(19) United States
(12) Patent Application Publication
(10) Pub. No.: US 2005/0105744 A1
(43) Pub. Date: May 19, 2005

(54) Method of improving speaker sound quality in vehicle by controlling speaker angle

(76) Inventor: Yong-Hee Lee, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,675

(22) Filed: Dec. 31, 2003

(30) Foreign Application Priority Data
Nov. 18, 2003 (KR) 10-2003-0081381

(51) Int. Cl. H04B 1/00; H04R 29/00

(52) U.S. Cl. 381/86; 381/56; 381/58

(57) ABSTRACT

A method of improving speaker sound quality in a vehicle by controlling a speaker's angle and sound pressure level output. Piezo-electric elements installed on seats are used to detect the number and positions of passengers, and simultaneously, ultrasonic sensors mounted at left and right lower ends of the roof are utilized to detect ear positions of passengers. A memory table describing the recommended angle and sound pressure level output for each standard sound range is used to determine speaker angles and sound pressure level outputs. The speakers are then adjusted according to the memory table data. The number and positions of passengers are detected at intervals to determine whether a change of number and/or positions requires the speakers to be readjusted.

### CROSS-REFERENCE TO RELATED APPLICATIONS

This application claims priority to Korean Application No. 10-2003-0081381, filed on Nov. 18, 2003, the disclosure of which is incorporated fully herein by reference.

### FIELD OF THE INVENTION

The present invention relates to a method of improving the sound quality of speakers in a vehicle by controlling the angle of speakers. More particularly, the present invention relates to a method of improving speaker sound quality in a vehicle by detecting the number, position, and height of passengers, and adjusting the mounted angles and positions of the speakers to provide an optimum sound quality in a vehicle.

### BACKGROUND OF THE INVENTION

Generally, sound tuning in a vehicle is achieved by forming a sound range with an emphasis on the driver's seat or a seat for a VIP (Very Important Person). Sound tuning is achieved by taking into account positions of specific individuals in conventional vehicles. Therefore, sound tuning face limitations when attempting to cater to all passengers in a vehicle face.

Another drawback in conventional sound tuning is that vehicle speakers are conventionally fixed to a specified position in terms of mounted positions and angles, making it difficult to form an adequate sound range for any given passenger's position. In the case of tweeters (speakers that generate the higher frequencies), it is also difficult to adjust and angle tweeters directly toward a passenger's ears. Yet another drawback is that most of the speakers are positioned below the level of door handles, resulting in an inefficient delivery of quality sound.

### SUMMARY OF THE INVENTION

The present invention is a method of improving speaker sound quality in a vehicle by detecting the number, position, and height of passengers, and then adjusting the mounted angles and positions of the speakers, thus enabling optimum sound quality in a vehicle. The method of improving speaker sound quality in a vehicle by controlling a speaker's angle comprises the steps of: setting up a standard sound range based upon the number and positions of passengers in a vehicle; storing data in a memory table that indicates the appropriate speaker angles for each standard sound range; detecting passenger information (including the number of passengers, each passengers' position, and each passengers' ears' positions); reading from the memory table the angles of speakers corresponding to the passenger information to determine the movement angles of the speakers; and moving each speaker to the appropriate angle according to the passenger information and the corresponding data stored in the memory table.

### BRIEF DESCRIPTION OF THE DRAWINGS

For a better understanding of the nature and objects of the present invention, reference should be made to the following detailed description with the accompanying drawings, in which:

FIGS. 1 and 2 are schematic drawings illustrating a situation where positions of speakers are adjusted with reference to one passenger in a vehicle according to an embodiment of the present invention;

FIG. 3a is a schematic drawing illustrating a state where a position of a standard sound range is set up with reference to one passenger in a vehicle according to an embodiment of the present invention;

FIGS. 3b to 3d are schematic drawings illustrating states where positions of standard sound ranges are set up with reference to two, three and four passengers in a vehicle according to an embodiment of the present invention; and

FIG. 4 is a flow chart for executing a speaker angle adjustment according to an embodiment of the present invention.

### DETAILED DESCRIPTION OF THE PREFERRED EMBODIMENT

The preferred embodiment of the present invention will now be described in detail with reference to the annexed drawings, where the present embodiments are not limiting the scope of the present invention but are given only as an illustrative purpose.

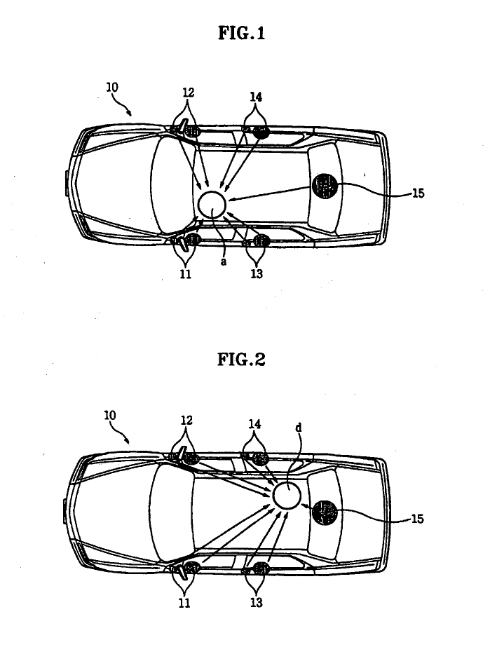

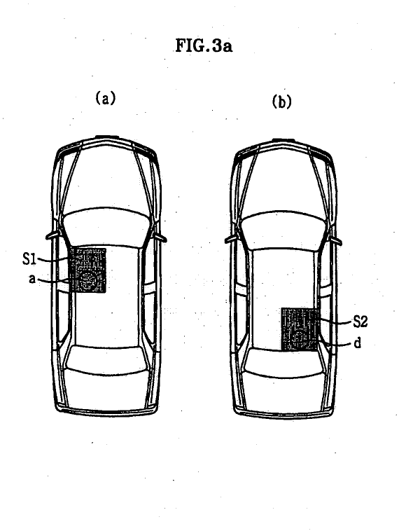

FIGS. 1 and 2 illustrate a case of only one passenger riding in a vehicle, and each figure illustrates a different passenger position and the corresponding speaker position adjustment. FIG. 1 illustrates a situation where a driver is seated in a vehicle, and FIG. 2 illustrates a situation where a VIP is seated at the rear seat of a vehicle. Speakers 11 to 15 of the present invention are each equipped with an angle adjustor (not shown) for adjusting the angle of the speakers.

In a vehicle with one driver seated in the driver's seat or a VIP seated at the rear seat, the left and right angles of speakers 11 to 15 are adjusted to conform to the position of the passenger. Particularly, an ultrasonic detecting sensor (not shown) is attached to the roof of a vehicle to detect the location of the top of a passenger's head at predetermined time intervals. When the sensor detects the location of the top of a passenger's head, speaker angles are adjusted to conform to a point approximately 15 cm below the area that the sensor detected as the top of the passenger's head. This is because ears are usually situated approximately 15 cm below from the top of one's head. A person seated in the back seat can move horizontally to the left or to the right so that when a predetermined time interval elapses, the sensor detects the position of the top of the passenger's head in the back seat, and the speakers are readjusted to conform to the shifted position.

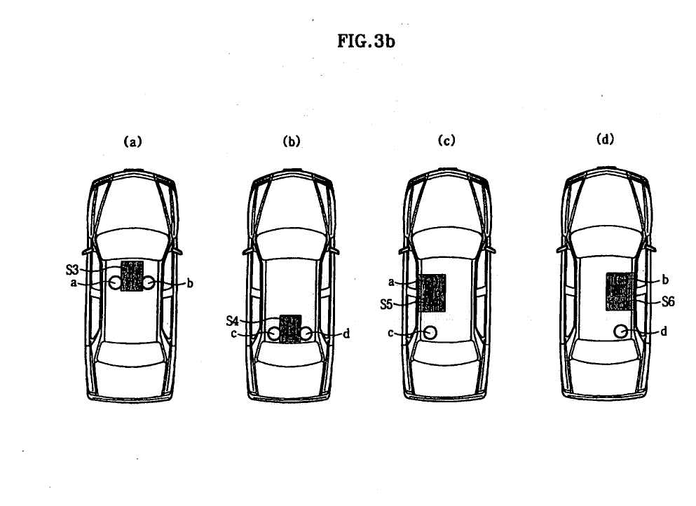

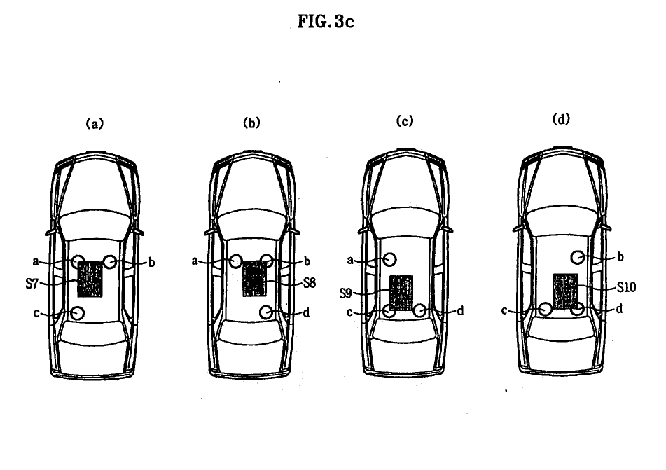

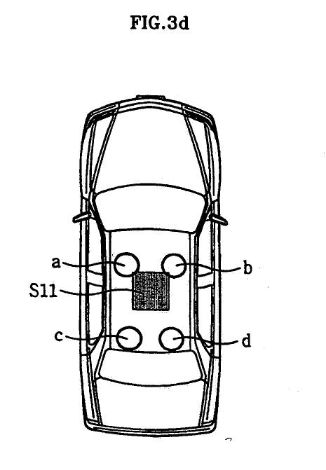

FIG. 3a illustrates two cases of a sound range for a single passenger. FIGS. 3b to 3d illustrate cases of a plurality of passengers riding in a vehicle, where each figure shows a position of a standard sound range. FIG. 3b shows two passengers, FIG. 3c depicts three passengers, and FIG. 3d illustrates four passengers riding in a vehicle.

In case illustrated in FIG. 3a where only one passenger is seated in a vehicle, standard sound ranges S1 and S2 are situated where each passenger is seated but should be arranged slightly in front of the seated position.

In FIG. 3b where two passengers are seated in a vehicle, positions of standard sound ranges are situated in a different manner. First, if a driver (a) is seated in the driver's seat and a passenger (b) is seated next to the driver's seat (hereinafter referred to as “front passenger seat”), standard sound range S3 is positioned slightly in front of the middle position of the two seats, as seen in drawing (a) of FIG. 3b. In a vehicle with two passengers seated in the back seats (c, d) (hereinafter “left passenger seat” and “right passenger seat”, respectively), standard sound range S4 is positioned slightly in front of the middle position of the two seats, as evidenced in drawing (b) of FIG. 3b. In a vehicle with two passengers seated in the left seats (a, c), standard sound range S5 is positioned slightly behind the front seat (a), as seen in drawing (c) of FIG. 3b. In a vehicle with two passengers seated in the right seats (b, d), standard sound range S6 is positioned slightly behind the front seat (b), as shown in drawing (d) of FIG. 3b.

With reference to FIG. 3c where three passengers are seated in a vehicle, standard sound ranges positioned in yet a different manner. First, in the case where passengers are seated at the driver's seat (a), the front passenger seat (b), and the left passenger seat (c), standard sound range S7 is positioned slightly to the left behind the driver's seat (a), as seen in drawing (a) of FIG. 3c. In a vehicle with a driver seated in the driver's seat (a) and two passengers in the right side of a vehicle (b, d), standard sound range S8 is positioned slightly to the right behind the front passenger seat (b), as shown in drawing (b) of FIG. 3c. In a vehicle with a driver seated in the driver's seat (a) and two passengers in the back seats of a vehicle (b, d), standard sound range S9 is positioned a little bit to the left and behind the driver's seat (a), as depicted in drawing (c) of FIG. 3c. In a vehicle with one passenger seated in the front passenger seat (b) and two passengers in the rear seats (c, d), standard sound range S10 is positioned slightly to the right and behind the front passenger seat (b), as shown in drawing (d) of FIG. 3c.

Finally, in a vehicle with four passengers as seen in FIG. 3d, standard sound range S11 is positioned slightly behind the midpoint between driver's seat (a) and front passenger seat (b).

As described in the above explanation, optimum sound quality can be provided in conformity with the number of riding passengers by adjusting speaker angles according to the positions of established standard sound ranges (S3 to S11) if there are multiple passengers riding in a vehicle. Additionally, the tops of each passengers' head are searched by the sensor, and the average value height of the passengers' ears are determined. The speakers' vertical angles are then adjusted to optimize the sound quality.

In the aforementioned explanation, in a vehicle with one passenger riding in the back seat, it is possible that the passenger will shift his position, making it necessary for the sensor, after a predetermined period of time, to sense the passenger's shift, which in turns readjusts the speaker angles to accommodate the passenger's new location within the vehicle. This re-sensing of passengers' positions and subsequent readjustment of the speaker angles also apply in situations where more than one passenger is located in the vehicle or more than one passenger shifts position within the vehicle.

As explained in the foregoing, eleven standard sound ranges (S1 to S11) are established based upon the positions and number of passengers riding in a vehicle, and a memory table (map table) is created based upon sound pressure output level ratios per speaker relative to the standard sound ranges (S1 to S11), one example of which is given in Table 1.

TABLE 1
Sound pressure output level ratios per speaker relative to the standard
sound ranges

| Speaker standard | | | | | |
|---|---|---|---|---|---|
| sound ranges | 11(FL) | 12(FR) | 13(RL) | 14(RR) | 15(P/T) |
| S1 | 1 | 0.5 | 0.8 | 0.3 | 1 |
| S2 | 0.3 | 0.8 | 0.5 | 1 | 1 |
| S3 | 1 | 1 | 0.4 | 0.4 | 1 |
| S4 | 0.4 | 0.4 | 1 | 1 | 1 |
| S5 | 1 | 0.5 | 0.8 | 0.5 | 1 |
| S6 | 0.5 | 1 | 0.5 | 0.8 | 1 |
| S7 | 0.8 | 0.5 | 1 | 0.8 | 1 |
| S8 | 0.5 | 0.8 | 0.8 | 1 | 1 |
| S9 | 0.5 | 0.3 | 1 | 0.8 | 1 |
| S10 | 0.3 | 0.5 | 0.8 | 1 | 1 |
| S11 | 1 | 1 | 1 | 1 | 1 |

Table 1 shows sound pressure output level ratios per speaker for each standard sound range. The relative sound output levels are listed, based upon a certain vehicle interior. In maintaining basic sound pressure output levels established for each standard sound range, the output levels can be adjusted and another form of memory table can be made in addition to the memory table of Table 1 that is tailored to the design of a specific vehicle's interior.

For example, suppose one passenger is seated in the VIP seat (d), in an established standard sound range S2. According to the memory table, a ratio of sound pressure output levels for each speaker 11, 12, 13, 14 and 15 is 0.3, 0.8, 0.5, 1, and 1. As a result, when the output level of speakers 14 and 15 are respectively given as ‘1’, and the other speakers may be farther away from speakers 14 and 15 than the configuration of speakers in the vehicle upon which Table 1 is based, then the other speakers must emit a larger sound pressure output level than that listed in Table 1. As a result, the ratio of sound pressure output levels for each speaker (11 to 13) may be set up as (0.3.0.9,0.7) instead of (0.3,0.8,0.5) in the above memory table.

Particularly, speaker 15 (Package Tray) mounted at the rear of the vehicle functions to generate a low sound out of various sounds, and has no great effect on the seated positions of the passengers such that the same sound pressure output ratio of ‘b 1’ is applied regardless of the seated positions of the passengers.

In another embodiment, the seated positions of the passengers can be detected by piezo-electric elements (not shown) mounted on the passengers' seats, and left and right angles of speakers are adjusted based upon the number and positions of passengers during sound tuning, which is then separately stored in memory. In yet another embodiment, with regard to the positions of ears of passengers, ultrasonic sensors are mounted at left and right lower ends of each door roof to detect optimum top positions of the passengers, and speakers are set up at positions approximately 15 cm down from the optimum top positions of the passengers. A motor mounted at the speakers can adjust the speaker angles based upon the positions and number of passengers.

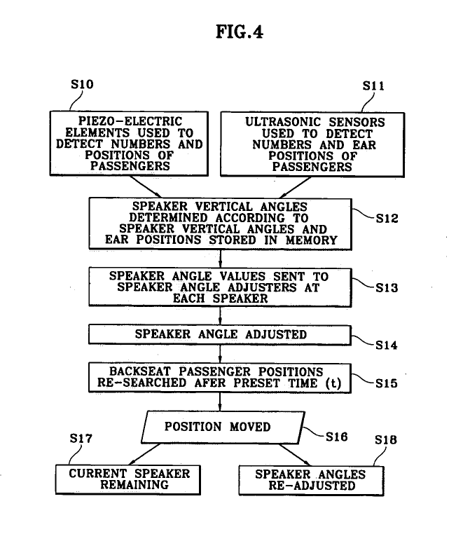

Next, FIG. 4 is a flow chart that describes a speaker angle adjusting process that improves sound quality according to an embodiment of the present invention (in FIG. 4, S denotes a step). First, the piezo-electric elements mounted at the seats are utilized to detect the number and positions of the passengers (S10), and the ultrasonic sensors are used to detect the number of passengers and the positions of their ears. Next, based on the measured data, left and right angle values of each speaker to be moved (based on the currently-positioned speakers) and vertical angle values are determined, and the sound pressure output level ratio with reference to the memory table are determined for each speaker (S12). Each established speaker angle value is transmitted to the speaker angle adjusters mounted at each speaker (S13) to adjust the speaker's angle (S14).

Additionally, passengers seated in the back seats are capable of shifting positions, and thus, the number and positions of the passengers are searched again after a predetermined period of time (t) has lapsed (S15). If the new data is identical to the data describing the passenger positions at the last readjustment of the speakers, then the present position of the speakers remains as is (S17). But if the new data is different from the data describing the passenger positions at the last readjustment of the speakers, then the speakers are readjusted (S18).

The foregoing description of the preferred embodiment of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto, and their equivalents.

As apparent from the foregoing, there is an advantage in the method of improving speaker sound quality in a vehicle by controlling a speaker's angle. According to an embodiment of the present invention, piezo-electric elements installed on seats are used to detect the number and positions of passengers, and simultaneously, ultrasonic sensors mounted at left and right lower ends of the roof are utilized to detect the positions of the passengers' ears. A memory table is made per standard sound range to conform to the number and positions of the passengers based on the passenger position data. Each speaker angle is adjusted by speaker angle adjusters mounted at each speaker so that sound pressure output can be generated according to the sound pressure output level ratio designated for each speaker to allow an optimum sound pressure most appropriate to an environment in consideration of the arbitrary number and positions of passengers to be outputted from each speaker, thereby maximizing the sound quality of the speakers.

1. A method of improving speaker sound quality in a vehicle, comprising the steps of:
determining standard sound ranges based upon the number and positions of passengers in a standard vehicle;
creating a memory table with data describing the most appropriate speaker angles and sound pressure output levels for each standard sound range;
detecting a passenger's position, number of passengers, and positions of the passengers' ears;
selecting the standard sound range that corresponds to the number and positions of passengers in the vehicle;
finding the speaker angles and sound pressure output levels from the memory table corresponding to the standard sound range from the selecting step;
adjusting each speaker so that each speaker satisfies the speaker angles and sound pressure output levels from the finding step.

2. The method in claim 1, wherein the sound standard range is divided into eleven seating arrangements and the eleven seating arrangements include:
a first instance of a driver seated in a driver's seat;
a second instance of a passenger seated in a VIP seat;
third to sixth instances where two passengers are seated in a driver's seat and a front passenger seat, two passengers are seated in the back seats in the left and right sides, one passenger is seated in the driver's seat and one passenger is seated in the left passenger seat, and one passenger is seated in the front passenger seat and another passenger is seated in the right passenger seat;
seventh to tenth instances where three passengers are seated in the two front seats and one passenger is seated in the left passenger seat, two passengers are seated in the front two seats and one passenger is seated in the right passenger seat, two passengers are seated in the back seat and a driver is seated in the driver's seat, and two passengers are seated in the back seats and one passenger is seated in the front passenger seat; and
an eleventh instance where four passengers are seated in the front two seats and in the back seats.

3. The method in claim 1, wherein the detecting step further comprises:
using piezo-electric elements mounted on seats to determine the number and positions of the passengers; and
using ultrasonic sensors mounted on a roof to determine ear positions of passengers.

4. A method of improving speaker sound quality in a vehicle, comprising the steps of:
detecting the number, seating positions, and ear positions of passengers;
determining a standard sound range based on the data obtained in the detecting step; and
adjusting angles and sound pressure level outputs of each speakers according to the standard sound range.

5. The method in claim 4, further comprising the steps of:
executing the detecting step at predetermined intervals; and
executing the determining and adjusting steps if the position of the passengers changed since the speakers were most recently adjusted.
